(19) United States
(12) Patent Application Publication
(10) Pub. No.: US 2007/0046563 A1
(43) Pub. Date: Mar. 1, 2007

(54) Slideshow-data generating apparatus, slideshow generating apparatus, control methods therefor and programs for controlling same

(75) Inventor: Arito Asai, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/508,816

(22) Filed: Aug. 24, 2006

(30) Foreign Application Priority Data
Aug. 25, 2005 (JP) 2005-243626

(51) Int. Cl. G09G 5/00

(52) U.S. Cl. 345/1.3

(57) ABSTRACT

An advanced slideshow is provided. To achieve this, a slideshow display period is divided into a plurality of units and a number of still images to be displayed is decided for every unit. One cell is selected from among a plurality of cells in accordance with the number of still images decided for each unit. A cell specifies positions at which still images displayed in the slideshow are to be rendered, and a moving image displayed as the background of the still images. In accordance with the cells selected, still images of a number of frames that differs for every unit are displayed in the slideshow.

### BACKGROUND OF THE INVENTION

1. Field of the Invention

This invention relates to an apparatus for generating slideshow data, a slideshow generating apparatus, as well as methods and programs for controlling such apparatus.

2. Description of the Related Art

A slideshow presents a display of still images of a plurality of frames in order. Such a slideshow may be a basic function of an operating system and can also display background images of a number of frames, which have been stored in a folder, in the form of a slideshow. A further example of the prior art generates a slideshow that can be displayed using a DVD (Digital Versatile Disk) player (see the specification of Japanese Patent Application Laid-Open No. 2004-194338).

Another example of the prior art is adapted to group still images of a plurality of frames (see the specification of Japanese Patent Application Laid-Open No. 2001-69458).

In any case, however, the prior art has not given consideration to the generation of a highly sophisticated slideshow.

### SUMMARY OF THE INVENTION

Accordingly, an object of the present invention is to generate a highly sophisticated slideshow.

According to a first aspect of the present invention, the foregoing object is attained by providing an apparatus for generating slideshow data, comprising: a dividing device (dividing means) for dividing a slideshow display period into a plurality of intervals; and a generating device (generating means) for generating a plurality of items of template moving-image data and a plurality of items of scenario data in each of the intervals obtained by division by the dividing device, wherein the plurality of items of template moving-image data represent template moving images in which still images are rendered at prescribed positions of each frame, the number of still images rendered being different for each item of template moving-image data, and the plurality of items of scenario data define rendering positions of the still images in association with the plurality of items of template moving image data.

The first aspect of the present invention also provides a control method suited to the above-described apparatus for generating slideshow data. Specifically, the first aspect of the present invention provides a method of controlling a slideshow-data generating apparatus, comprising the steps of: dividing a slideshow display period into a plurality of intervals; and generating a plurality of items of template moving-image data and a plurality of items of scenario data in each of the intervals obtained by division; wherein the plurality of items of template moving-image data represent template moving images in which still images are rendered at prescribed positions of each frame, the number of still images rendered being different for each item of template moving-image data, and the plurality of items of scenario data define rendering positions of the still images in association with the plurality of items of template moving image data.

The first aspect of the present invention also provides a program for implementing the above-described method of controlling the slideshow-data generating apparatus.

In accordance with the first aspect of the present invention, a slideshow display period is divided into a plurality of intervals. A plurality of items of template moving-image data and a plurality of items of scenario data are generated in each of the intervals. Since the plurality of items of template moving-image data and the plurality of items of scenario data are generated in each of the intervals, it is possible to produce a highly sophisticated slideshow in which a different display is presented in accordance with the number of still images to be displayed.

The slideshow display period preferably corresponds to music. In such case the dividing device would divide the music into a plurality of musical intervals.

According to a second aspect of the present invention, the foregoing object is attained by providing a slideshow generating apparatus comprising: a slideshow data storage device for storing a plurality of items of template moving-image data and a plurality of items of scenario data in each of a plurality of intervals into which a slideshow display period has been divided, wherein the plurality of items of template moving-image data represent template moving images in which still images are rendered at prescribed positions of each frame, the number of still images rendered being different for each item of template moving-image data, and the plurality of items of scenario data define rendering positions of the still images in association with the plurality of items of template moving image data; a still-image data input device for inputting still-image data representing a plurality of frames of still images; a calculating device (calculating means) for calculating, from among the plurality of frames of still images represented by the still-image data that has been input from the still-image data input device, each of a number of still images of a plurality of frames included in still-image groups that correspond to respective ones of the intervals and contain a plurality of frames of still images; a deciding device (deciding means) for deciding template moving-image data and scenario data, which correspond to the number calculated by the calculating device, from among the plurality of items of template moving-image data and plurality of items of scenario data of the interval corresponding to a still-image group that gives the number calculated by the calculating device; and a moving image generating device (moving image generating means) for generating display moving-image data using the template moving-image data and scenario data decided by the deciding device and still images contained in a still-image group that has been used in processing in the deciding device.

The second aspect of the present invention also provides a control method suited to the above-described slideshow generating apparatus. Specifically, the second aspect of the present invention provides a method of controlling a slideshow generating apparatus, comprising the steps of: storing a plurality of items of template moving-image data and a plurality of items of scenario data in each of a plurality of intervals into which a slideshow display period has been divided, wherein the plurality of items of template moving-image data represent template moving images in which still images are rendered at prescribed positions of each frame, the number of still images rendered being different for each item of template moving-image data, and the plurality of items of scenario data define rendering positions of the still images in association with the plurality of items of template moving image data; inputting still-image data representing a plurality of frames of still images; calculating, from among the plurality of frames of still images represented by the still-image data that has been input, each of a number of still images of a plurality of frames included in still-image groups that correspond to respective ones of the intervals and contain a plurality of frames of still images; deciding template moving-image data and scenario data, which correspond to the number calculated, from among the plurality of items of template moving-image data and plurality of items of scenario data of the interval corresponding to a still-image group that gives the number calculated; and generating display moving image data using the template moving-image data and scenario data decided and still images contained in a still-image group that has been used in processing for rendering the decision of the decision step.

The second aspect of the present invention also provides a program for implementing the above-described method of controlling the slideshow generating apparatus.

In accordance with the second aspect of the present invention, a plurality of items of the template moving-image data and a plurality of items of the scenario data have been stored. If still-image data representing a plurality of frames of still images is input, each of a number of still images of a plurality of frames included in still-image groups that correspond to respective ones of a plurality of intervals into which a slideshow display period has been divided is calculated. Template moving-image data and scenario data that correspond to the number calculated is decided from among the plurality of items of template moving-image data and plurality of items of scenario data of the interval corresponding to a still-image group that gives the number calculated. Moving-image data for display for the purpose of presenting a slideshow is generated using the template moving-image data and scenario data decided and still images contained in a still-image group that was used in processing in the deciding device.

In accordance with the second aspect of the present invention, template moving-image data and scenario data suited to the number of still images is decided for every interval. Moving image data for display is generated using the template moving-image data decided. A slideshow that conforms to the number of still images caused to be displayed can be presented, the slideshow not being one in which the number of still images displayed simultaneously has been decided in advance. In particular, a slideshow in which the number of still images caused to be displayed simultaneously can be changed on a per-interval basis is obtained.

The slideshow display period may correspond to music, and the dividing device may divide the music into a plurality of intervals of music. In such case the slideshow data storage device would store music data for outputting the intervals of music in addition to the plurality of items of template moving-image data and plurality of items scenario data. The deciding device would decide template moving-image data, scenario data and music data, which correspond to the number calculated by the calculating device, from among the plurality of items of template moving-image data, the plurality of items of scenario data and interval of music data of the interval corresponding to a still-image group that gives the number calculated by the calculating device. Furthermore, moving-image data for display would be generated using the template moving-image data, scenario data and music data decided by the deciding device and still images contained in a still-image group that has been used in processing in the deciding device.

The apparatus may further comprise a still-image group generating device for generating the still-image groups, which correspond to respective ones of the intervals, from among a plurality of still images represented by the still-image data that has been input from the still-image data input device. In this case the calculating device would calculate each of a number of still images of a plurality of frames included in a still-image group that has been generated by the still-image group generating device.

The still-image group generating device may arrange the plurality of frames of still images, which are represented by the still-image data that has been input from the still-image data input device, in the order in which the still images were shot, and generate the still-image groups corresponding to respective ones of the intervals based upon the number of intervals.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a slideshow-data generating apparatus;

FIG. 2 illustrates the relationship among units obtained by division, time, music and cells;

FIG. 3 illustrates an example of a scenario definition file;

FIG. 4 illustrates an example of a scenario file;

FIG. 5 is a block diagram illustrating the electrical structure of a slideshow generating apparatus;

FIG. 6 illustrates the relationship among units obtained by division, time, music and selected cells;

FIGS. 7 to 9 illustrate examples of images displayed as a slideshow; and

FIG. 10 is a flowchart illustrating processing executed by the slideshow generating apparatus.

### DESCRIPTION OF THE PREFERRED EMBODIMENT

A preferred embodiment of the present invention will now be described in detail with reference to the drawings.

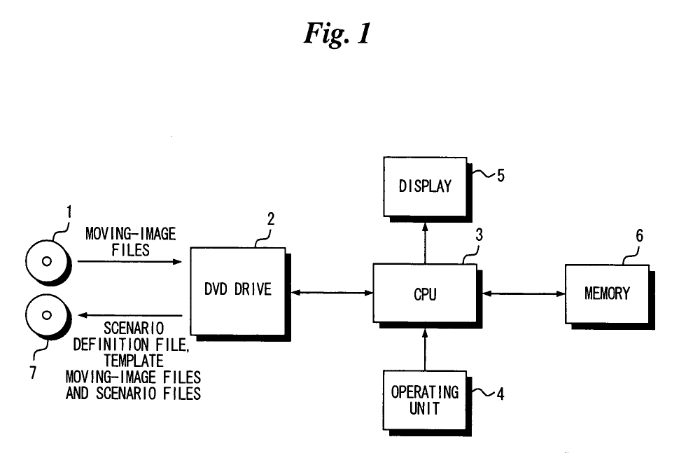

FIG. 1 is a block diagram illustrating the electrical structure of a slideshow-data generating apparatus embodying the present invention.

Slideshow data is data indicative of a basic model of a slideshow. Specifically, still images are provided by a user, whereby the still images are rendered on each frame of an image that constitutes a moving image, thereby presenting a display of the slideshow. The operation of the overall slideshow-data generating apparatus is controlled by the CPU 3. The apparatus is provided with an operating unit 4. An operation signal that is output from the operating unit 4 is input to the CPU 3.

Stored on a DVD (Digital Versatile Disk) 1 for moving-image files is a background moving-image file in which music is output together with a representation of a background moving image that forms the background of the still images when a slideshow is displayed. The background moving-image file is loaded into a DVD drive 2 and the background moving-image file is read thereby. The background moving-image file that has been read is applied to a memory 6, where the file is stored temporarily. A program for controlling a moving image, described later, also is stored in the memory 6. By applying the background moving-image file to a display unit 5, the background moving image is displayed. By viewing the background moving image, one can determine the timings at which the background moving image is divided into a plurality of time intervals, as will be described later.

In this embodiment, one unit of a display period of a slideshow is divided into a plurality of time intervals each of which is referred to as a “unit”. A background moving-image file is divided up in accordance with the units obtained by division, and a template moving-image file that corresponds to each unit is generated. The number of frames of still images displayed in the slideshow changes for every unit obtained by division.

A scenario file, described later, defines positions, etc., at which still images are rendered. Furthermore, a scenario definition file, described later, is one that gives a description of template moving-image files and scenario files usable in each unit. The scenario definition file and scenario files are input to the slideshow-data generating apparatus using the operating unit 4. The scenario definition file and scenario files that have been input are applied to the memory 6, where the files are stored temporarily.

The background moving-image file that has been stored temporarily in the memory 6 is divided to generate template moving-image files. The template moving-image files and the input scenario definition file and scenario files are applied to the DVD drive 2, and the DVD drive 2 records these on a slideshow DVD 7 loaded into the DVD drive 2.

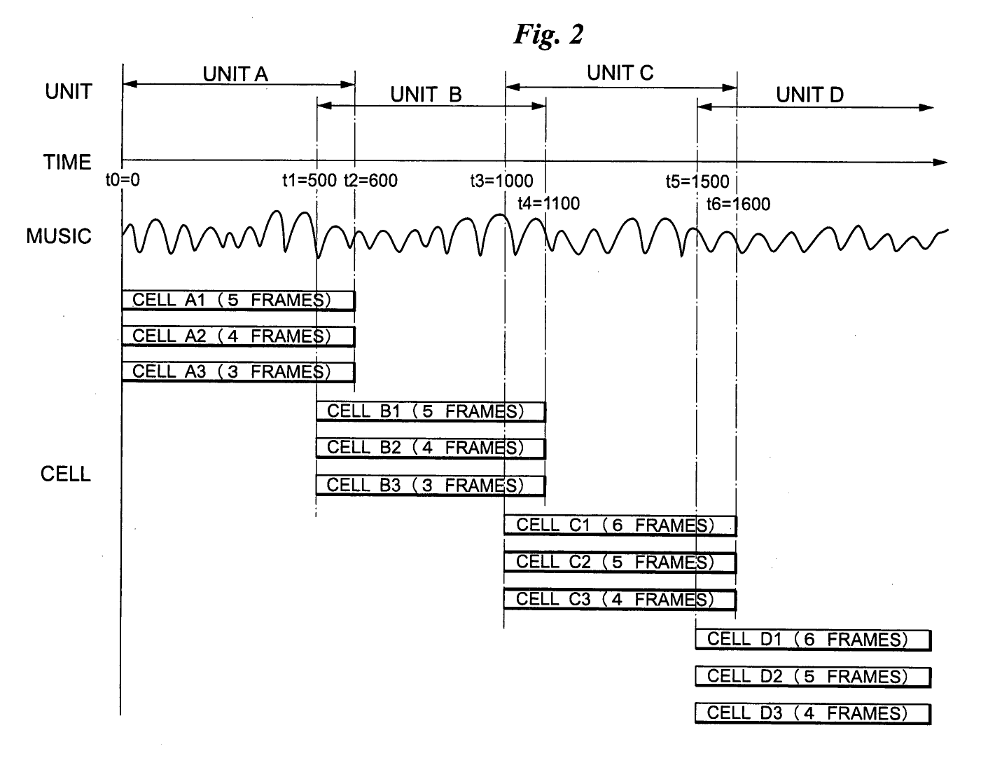

FIG. 2 illustrates the relationship among units, time, music accompanying a moving image and cells.

In this embodiment, as mentioned above, the display period of a slideshow is divided into a plurality of units, such as Units A and B. For example, time t0=0 to t2=600 is the first Unit A, and time t1=500 to t4=1100 is the second Unit B. Although mutually adjacent units in the illustration of FIG. 2 overlap each other, one may follow the other without overlapping it. The same number of frames of still images is displayed in each of the plurality of units obtained by dividing the slideshow display period. A slideshow can be presented in which the number of still images differs for every unit. It goes without saying that the same number of frames of still images may be displayed as a slideshow in different units.

A plurality of cells have been stipulated in association with each of the units. For example, three cells, namely Cells A1, A2 and A3 have been stipulated for Unit A. A cell indicates a combination of the file name of a template moving-image file obtained by division, the file name of a scenario file and the number of frames of still images rendered in the unit. If a cell is specified in a unit, the number of frames of still images displayed in the slideshow in this unit, how the slideshow is presented and the background moving image are decided. Conversely, if the number of frames of still images presented in the slideshow in a unit is decided, the corresponding cell is decided. Such cells are contained in the scenario definition file.

In the example shown in FIG. 2, three cells have likewise been stipulated for each of the units. However, it goes without saying that a different number of cells may be stipulated for every unit.

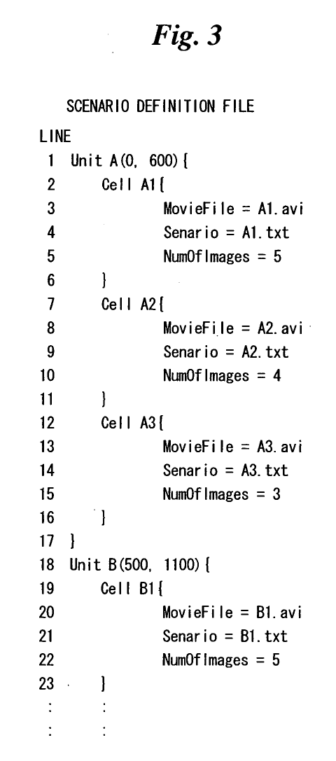

FIG. 3 illustrates an example of a scenario definition file.

A scenario definition file defines, cell by cell in accordance with each unit, the file name of a template moving-image file, the file name of a scenario file and the number of frames of still images, as mentioned above.

Lines 1 to 17 relate to Unit A.

Line 1 indicates the period from starting time to end time of Unit A.

Lines 2 to 6 stipulate Cell A1. Line 3 indicates that the file name of the template moving-image file used in Cell A1 is A1.avi. Line 4 indicates that the scenario data file used in Cell A1 is A1.txt. Line 5 indicates that the number of frames of still images used in Cell A1 is five.

Lines 7 to 11 stipulate Cell A2, and lines 12 to 16 stipulate Cell A3. The file names of template moving-image files, file names of scenario files and number of frames of still image used in Cells A2 and A3 will be understood from the description above.

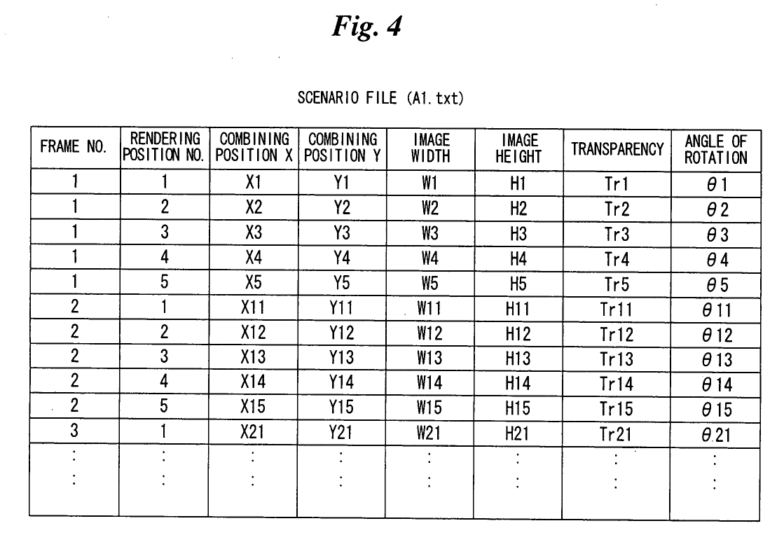

FIG. 4 illustrates an example of a scenario file (of file name A1.txt).

A scenario file stipulates the rendering of a still image in one frame of an image that constitutes a moving image represented by a template moving-image file. A rendering position number, combining position X, combining position Y, image width, image height, transparency and angle of rotation are defined in correspondence with the frame number of the image of each frame constituting the moving image.

The rendering position number is a number that identifies the rendering position of a still image in one frame of an image constituting the moving image. It will be understood that since rendering position numbers corresponding to Frame No. 1 are 1 to 5, still images rendered in the image of Frame No. 1 are five in number. The number of rendering position numbers corresponds to the number of frames of still images which is stipulated in the scenario definition file.

The combining positions X and Y define the rendering position of a still image. The still image is positioned in such a manner that the upper-left corner of the still image to be rendered will conform to the coordinates stipulated by the combining positions X and Y.

Image width and height define the size of the still image. The still image is subjected to enlargement or reduction processing in such a manner that the still image to be rendered will fit into the area stipulated by the width and height of the image.

Transparency defines the transparency of the still image. Transparency is greater than 0 and equal to or less than 1.0. The higher the transparency (the closer transparency is to 1.0), the higher the percentage of visibility of the still image to be rendered and the lower the percentage of visibility of the background image. The lower the transparency, the lower the percentage of visibility of the still image to be rendered and the higher the percentage of visibility of the background image. If transparency is 1.0, only the still image and not the background image can be seen at the portion where the background image and still image overlap. The value of a pixel of an image for display is obtained based upon Equation (1) below utilizing transparency.
(value of pixel of display image)=(value of pixel of background image)×(1−transparency)+(value of pixel of still image)×(transparency) Eq. 1

Angle of rotation defines the angle of rotation of the still image and indicates the relative angle of rotation with respect to the rendering area of the still image displayed in the rendering area of the still image stipulated by the above-mentioned combining position X, combining position Y, image width and image height.

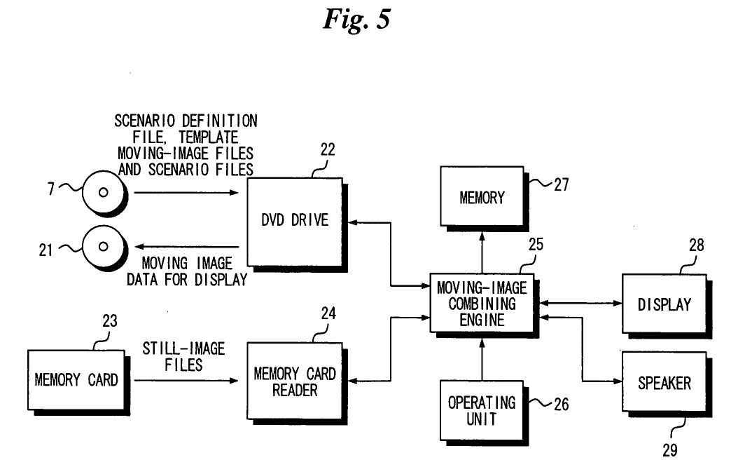

FIG. 5 is a block diagram illustrating the electrical structure of a slideshow generating apparatus that presents a slideshow using slideshow data that has been generated in the manner described above.

The slideshow generating apparatus is provided with an operating unit 26 that is operated by the user. An operating signal that is output from the operating unit 26 is input to a moving-image combining engine 25.

As mentioned above, when the slideshow data DVD 7 on which the slideshow image data of a scenario definition file, template moving-image files and scenario files has been recorded is loaded into a DVD drive 22, the slideshow data that has been recorded on the slideshow DVD 7 is read out and stored temporarily in a memory 27. A program for controlling operation, described later also is stored in the memory 27.

A memory card 23 belonging to the user is loaded into a memory card reader 24. A number of still-image files have been grouped beforehand in association with each above-mentioned unit and have been recorded on the memory card 23. For example, five frames of still images are grouped in a first group corresponding to Unit A, four frames of still images are grouped in a second group corresponding to Unit B, and four frames of still images are grouped in a third group corresponding to Unit C. Still-image files are similarly grouped with regard to other units. A number of frames of still images that have been read from the memory card 23 in group form are also applied to the memory 27 and stored there temporarily.

A cell that corresponds to the number of frames of still images represented by grouped still-image files is specified in the moving-image combining engine 25 from within a scenario definition file that has been stored in the memory 27. The file name of a template moving-image file and the file name of a scenario file contained in the specified cell are read. Display moving-image data representing a slideshow in terms of the unit is generated using the template moving-image file and scenario file having the read file names and the corresponding still-image files. If display moving-image data is generated in regard to all units, the display moving-image data generated is applied to a display unit 28, whereby a slideshow is presented on the display screen of the display unit 28. Further, music data accompanying the display moving-image data is applied to a speaker 29, whereby music is output from the speaker 29.

Furthermore, the display moving-image data generated is applied from the moving-image combining engine 25 to the DVD drive 22, whereby the display moving-image data is recorded on a slideshow DVD 21 loaded in the DVD drive 22. The slideshow DVD 21 is loaded into a DVD player or the like so that the slideshow can be displayed.

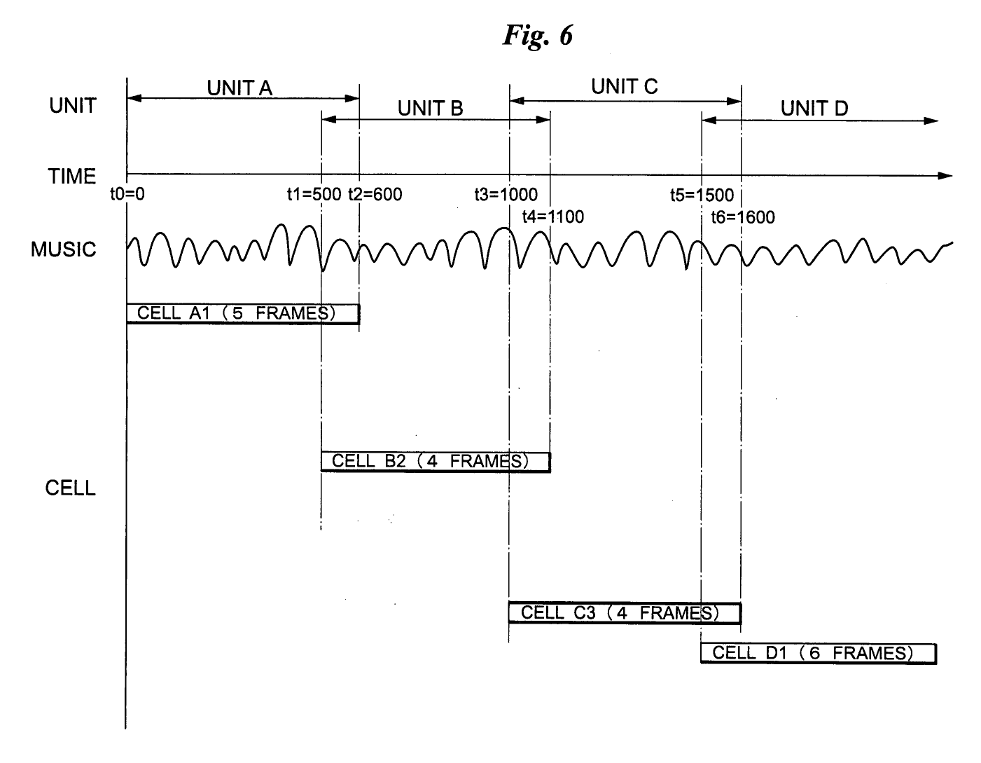

FIG. 6 illustrates the relationship among units, time, music and selected cells.

As mentioned above, it is assumed that among the still images that have been grouped, the number of frames of still images corresponding to Unit A is five, the number of frames of still images corresponding to Unit B is four, and the number of frames of still images corresponding to Unit C is four. In this case, Cell A1, in which the number of frames of still images stipulated is five, is selected in Unit A. Similarly, Cell B2 is selected in Unit B and Cell C3 is selected in Unit C.

In the time interval of Unit A, the moving image having the file name A1.avi specified by Cell A1 is displayed as background of still images. Further, the five frames of still images rendered in the time interval of Unit A are displayed in a slideshow in such a manner that they are rendered at the rendering positions, etc., defined by the scenario file having the file name A1.txt specified in Cell A1.

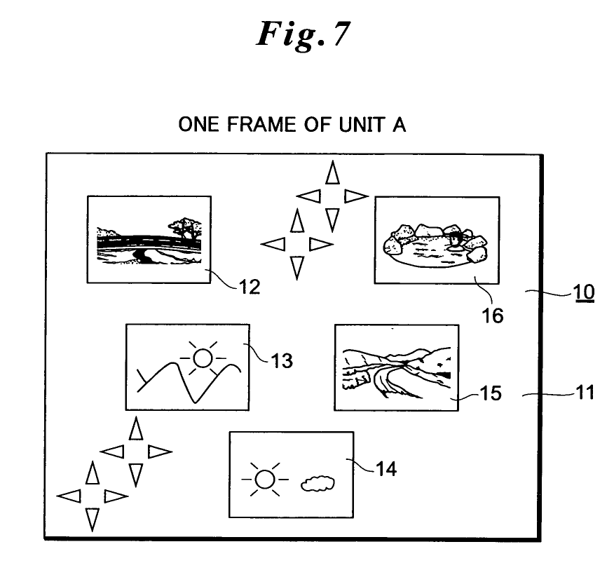

FIG. 7 illustrates one frame of an image (slideshow image) that constitutes the slideshow displayed in Unit A.

Five frames of still images 12 to 16 are rendered in a slideshow image 10 displayed in the time interval of Unit A. The positions at which the still images 12 to 16 are rendered are stipulated by the scenario file specified by the file name A1.txt described in the selected Cell A1, as mentioned above. A moving image 11 represented by the template moving-image file specified by the file name A1.avi described in Cell A1 is displayed as the background of the still images 12 to 16. In the time interval of Unit A, a slideshow is presented in which the still images 12 to 16 are rendered at the positions stipulated by the scenario file specified by the file name A1.txt, and a moving image represented by the template moving-image data specified by the file name A1.avi is displayed as the background.

Similarly, in the time interval of Unit B, a slideshow is presented in which a moving image having the file name specified by Cell B2 is displayed as the background of still images, and four frames of still images rendered in the time interval of Unit B are rendered at rendering positions, etc., stipulated by the scenario data specified in Cell B2.

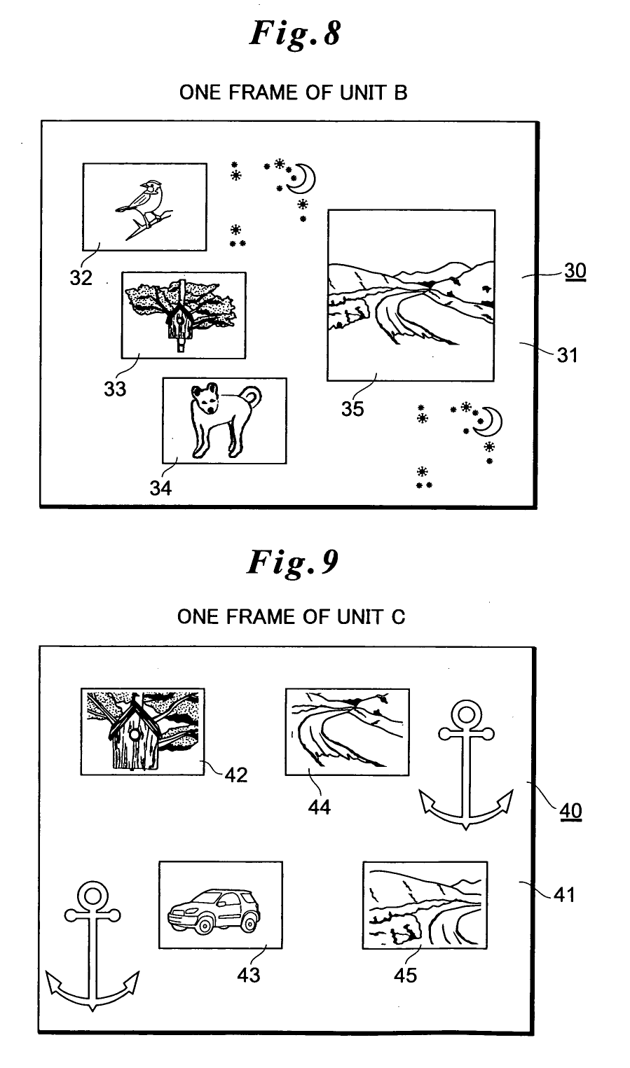

FIG. 8 illustrates one frame of a slideshow image displayed in Unit B.

In the time interval also of Unit B, four frames of still images 32 to 35 are contained in a slideshow image 30, and a moving image is displayed as the background of these still images 32 to 35. (In FIG. 8, one frame of an image 31 constituting this moving image is being displayed.) In the time interval of Unit B, in the manner described above, rendering positions, etc., of the still images 32 to 35 are decided by the scenario file specified by Cell B2 selected in Unit B, and a moving image represented by the template moving-image file is displayed as the background of the still images 32 to 35.

FIG. 9 illustrates one frame of a slideshow image displayed in Unit C.

In the time interval also of Unit C, four frames of still images 42 to 45 are contained in a slideshow image 40, and a moving image is displayed as the background of these still images 42 to 45. (In FIG. 9, one frame of an image 41 constituting this moving image is being displayed.) In the time interval also of Unit C, in the manner described above, rendering positions, etc., of the still images 42 to 45 are decided by the scenario file specified by Cell C3 selected in Unit C, and a moving image represented by the template moving-image file is displayed as the background of the still images 42 to 45.

Thus, the number of frames of still images displayed from unit to unit can be changed, and the background moving image can be changed as well. This makes it possible to provide an advanced slideshow.

A period during which units overlap each other, as in the period t1=500 to t2=600 in which Unit A and Unit B overlap, is a period in which the images constituting the slideshow displayed in the time interval of Unit A and the images constituting the slideshow displayed in the time interval of Unit B are displayed in superposition. Of course, in a case where the music track in Unit A differs from that in Unit B, either music track is output during the period of overlap. If the same music track has been split up, the same music track will be output even if there is overlap of units.

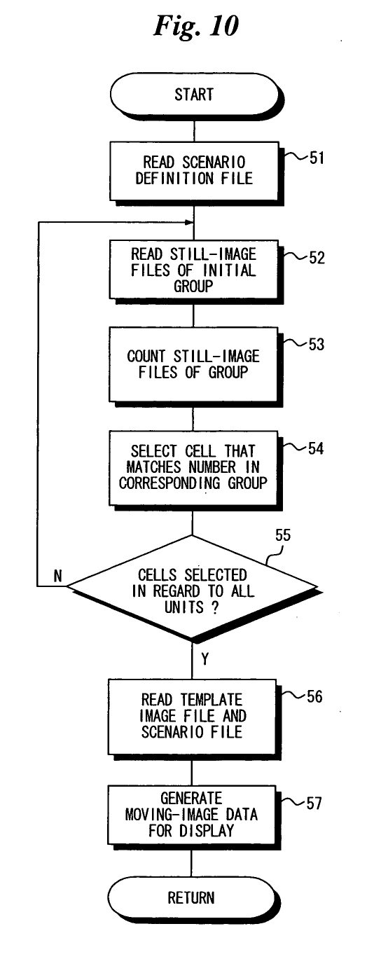

FIG. 10 is a flowchart illustrating processing executed by the slideshow generating apparatus.

First, a scenario definition file, template moving-image files, scenario files and still-image files are all stored temporarily in the memory 27. This is followed by reading the scenario definition file from the memory 27 (step 51). Next, the still-image files of an initial group are read (step 52) and the number of still-image files read is counted (step 53). In the unit that corresponds to the still-image files the number of which has been counted, the cell that matches this number is selected (step 54).

The processing of steps 52 to 54 is repeated until cells are selected in regard to all of the units that were obtained by dividing the slideshow display period (step 55).

When a cell is selected, the template moving-image file and scenario file specified by the selected cell are read (step 56). Moving-image data for display is generated in regard to all of the units (step 57). The moving-image data for display is such that still images represented by the still-image files are rendered at the positions stipulated by the scenario file while the background becomes the moving image represented by the read template moving-image data. A slideshow is displayed by reproducing the moving-image data for display.

In the embodiment set forth above, the still-image files that have been recorded on the memory card 23 have been grouped in advance. However, it may be so arranged that grouping is performed automatically rather than in advance. For example, the still-image files can be arranged in the order of the times at which they were shot and then can be grouped by dividing them into a number obtained by subtracting 1 from the total number of units. Further, grouping can be performed by clustering together still images that resemble one another.

Furthermore, it may be so arranged that in a case where a number of frames of still images that have been grouped is greater than a number of frames of still images stipulated by a cell that has been prepared on a per-unit basis, the images are evaluated based upon their amounts of exposure and degree to which they are in focus, etc., and images having low image evaluation values are excluded from the still images that are to be displayed. In this way the number of frames of still images grouped becomes the number of frames of still images stipulated by the cell.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for generating slideshow data, comprising:
a dividing device for dividing a slideshow display period into a plurality of intervals; and
a generating device for generating a plurality of items of template moving-image data and a plurality of items of scenario data in each of the intervals obtained by division by said dividing device, wherein said plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data.

2. The apparatus according to claim 1, wherein the slideshow display period corresponds to music, and said dividing device divides the music into a plurality of musical intervals.

3. A slideshow generating apparatus comprising:
a slideshow data storage device for storing a plurality of items of template moving-image data and a plurality of items of scenario data in each of a plurality of intervals into which a slideshow display period has been divided, wherein the plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data;
a still-image data input device for inputting still-image data representing a plurality of frames of still images;
a calculating device for calculating, from among the plurality of frames of still images represented by the still-image data that has been input from said still-image data input device, each of a number of still images of a plurality of frames included in still-image groups that correspond to respective ones of the intervals and contain a plurality of frames of still images;
a deciding device for deciding template moving-image data and scenario data, which correspond to the number calculated by said calculating device, from among the plurality of items of template moving-image data and plurality of items of scenario data of the interval corresponding to a still-image group that gives the number calculated by said calculating device; and
a moving image generating device for generating display moving-image data using the template moving-image data and scenario data decided by said deciding device and still images contained in a still-image group that was used in processing in said deciding device.

4. The apparatus according to claim 3, wherein the slideshow display period corresponds to music, and the dividing period divides the music into a plurality of musical intervals;
said slideshow data storage device stores music data for outputting intervals of music in addition to the plurality of items of template moving-image data and plurality of items scenario data; and
said deciding device decides template moving-image data, scenario data and music data, which correspond to the number calculated by said calculating device, from among the plurality of items of template moving-image data, the plurality of items of scenario data and interval of music data of the interval corresponding to the still-image group that gives the number calculated by said calculating device;
moving-image data for display being generated using the template moving-image data, scenario data and music data decided by said deciding device and still images contained in the still-image group that was used in processing in said deciding device.

5. The apparatus according to claim 3, further comprising a still-image group generating device for generating the still-image groups, which correspond to respective ones of the intervals, from among a plurality of frames of still images represented by the still-image data that has been input from said still-image data input device;
wherein said calculating device calculates each of a number of still images of a plurality of frames included in still-image groups that have been generated by said still-image group generating device.

6. The apparatus according to claim 5, wherein said still-image group generating device arranges the plurality of frames of still images, which are represented by the still-image data that has been input from said still-image data input device, in the order in which the still images were shot, and generates the still-image groups corresponding to respective ones of the intervals based upon the number of intervals.

7. A method of controlling a slideshow-data generating apparatus, comprising the steps of:
dividing a slideshow display period into a plurality of intervals; and
generating a plurality of items of template moving-image data and a plurality of items of scenario data in each of the intervals obtained by division; wherein said plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data.

8. A method of controlling a slideshow generating apparatus, comprising the steps of:
storing a plurality of items of template moving-image data and a plurality of items of scenario data in each of a plurality of intervals into which a slideshow display period has been divided, wherein said plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data;
inputting still-image data representing a plurality of frames of still images;
calculating, from among the plurality of frames of still images represented by the still-image-data that has been input, each of a number of still images of a plurality of frames included in still-image groups that correspond to respective ones of the intervals and contain a plurality of frames of still images;
deciding template moving-image data and scenario data, which correspond to the number calculated, from among the plurality of items of template moving-image data and plurality of items of scenario data of the interval corresponding to a still-image group that gives the number calculated; and
generating display moving image data using the template moving-image data and scenario data decided and still images contained in a still-image group that has been used in processing for rendering the decision of the decision step.

9. A program for controlling a slideshow-data generating apparatus so as to cause the apparatus to:
divide a slideshow display period into a plurality of intervals; and
generate a plurality of items of template moving-image data and a plurality of items of scenario data in each of the intervals obtained by division; wherein said plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data.

10. A program for controlling a slideshow generating apparatus so as to cause the apparatus to:
store a plurality of items of template moving-image data and a plurality of items of scenario data in each of a plurality of intervals into which a slideshow display period has been divided, wherein said plurality of items of template moving-image data represent template moving images in which still images are rendered at prescribed positions of each frame, the number of still images rendered being different for each item of template moving-image data, and said plurality of items of scenario data define rendering positions of the still images in association with the plurality of items of template moving image data;
input still-image data representing a plurality of frames of still images;
calculate, from among the plurality of frames of still images represented by the still-image data that has been input, each of a number of still images of a plurality of frames included in still-image groups that correspond to respective ones of the intervals and contain a plurality of frames of still images;
decide template moving-image data and scenario data, which correspond to the number calculated, from among the plurality of items of template moving-image data and plurality of items of scenario data of the interval corresponding to a still-image group that gives the number calculated; and
generate display moving image data using the template moving-image data and scenario data decided and still images contained in a still-image group that has been used in processing for rendering the decision.
